(19) United States
(12) Patent Application Publication
(10) Pub. No.: US 2011/0137931 A1
(43) Pub. Date: Jun. 9, 2011

(54) Search Strategy Capture and Retrieval Method

(75) Inventors: George William Erhart, Loveland, CO (US); Valentine C. Matula, Granville, OH (US); David Joseph Skiba, Golden, CO (US); Thomas C. Hanson, Boulder, CO (US)

(73) Assignee: AVAYA INC., Basking Ridge, NJ (US)

(21) Appl. No.: 12/644,130

(22) Filed: Dec. 22, 2009

Related U.S. Application Data
(60) Provisional application No. 61/267,704, filed on Dec. 8, 2009.

(51) Int. Cl. G06F 17/30

(52) U.S. Cl. 707/769; 707/802; 707/E17.044; 707/E17.108

(57) ABSTRACT

A system that improves searching based on a search term by first capturing successful search strategies and then offering them in the results of a subsequent search based on the same search term. In the illustrative embodiment of the present invention, a search engine collects successful search sequences based on a search term, a database stores the search sequences and then provides them to the search engine in response to subsequent uses of the search term. The search engine comprises a data capture mechanism that gives a searcher a way of indicating when a successful search has been completed.

### CROSS REFERENCE TO RELATED APPLICATIONS

This application claims the benefit of U.S. provisional application No. 61/267,704, filed on Dec. 8, 2009, and entitled “Search Strategy Capture and Retrieval Method.” The concepts, but not necessarily the nomenclature, of this provisional application are hereby incorporated by reference.

### FIELD OF THE INVENTION

The present invention relates to data processing systems in general, and, more particularly, to searching using search terms.

### BACKGROUND OF THE INVENTION

When conducting an Internet search based on a search term, a user faces a torrent of results that are often unhelpful and unfocused. Submitting a search term generally yields a large number—sometimes a huge number—of Internet locations each of which contains a match to the submitted search term. Likewise, when calling into an interactive voice response system, a user generally faces many choices and layers of sub-choices.

In an Internet search generally, a user submits a search term to an Internet search engine. Google is an example of an Internet search engine. The Internet search engine finds locations (or destinations) throughout the Internet that have a match to the user's search term. These destinations are stored in (or hosted by) web servers. A web server is a computer that stores information that is accessible over the Internet (or the World Wide Web), such as an online store, a document, an online dictionary, etc.

For example, submitting the search term “Avaya” to the Google search engine yields over one million results. Each result is an identifier that points to a destination hosted by some server on the Internet.

Receiving a million results for a search term is not necessarily helpful to the searcher's objective. The fact that the search term matches something at a destination site does not guarantee that the destination is relevant, desirable, or helpful.

One technique for narrowing down the search results is to submit to the search engine a more complex search term, for example, “Avaya employment benefits.” Even this search term yields over 50,000 results.

To successfully conclude the search, therefore, the user might navigate numerous destinations before achieving the sought-after objective of the search. This can be costly and time consuming, or worse, can lead the user astray through endless circumnavigation.

A more focused approach is required.

### SUMMARY OF THE INVENTION

The present invention improves searching based on a search term by first capturing successful search strategies and then offering them either alone or within the results of a subsequent search based on the same search term. In the illustrative embodiment of the present invention, a search engine collects successful search sequences based on a search term, a database stores the successful search sequences and then provides them to the search engine in response to subsequent uses of the search term. The search engine comprises a data capture mechanism that gives a searcher a way of indicating when a successful search has been completed.

In contrast to the prior art, which generally addresses the destination endpoint of a search, the present invention captures successful search strategies, i.e., sequences of destinations that ultimately lead to a successful search. What is a successful search? A successful search is defined in reference to the searcher's objective in doing the search, for example, making a purchase, consulting an expert, reading a document, providing feedback, etc.

Critically, a successful search is not merely a sprint to a destination, although it could be that simple in some cases. The prior art is generally addressed to sprinting to the destination. However, there are situations where the search strategy itself is useful to subsequent searchers and should be captured (or learned) and used again later.

For example, when intending to purchase a given product, a buyer might first navigate some blogs or reviews of the product, might then navigate the manufacturer's web site, might then navigate some vendors of the product, and might finally settle on a vendor site and actually buy the product. An expert buyer might have developed a strategy for online purchasing by relying on certain reputable reviewers or manufacturers. Thus, the expert buyer's online strategy can be helpful and useful to others.

In another example directed at a corporate help center, an expert's strategy for navigating in response to customer trouble calls is valuable to learn and then reuse. Thus, the corporate help center would first use the present invention to capture successful search strategies used by its expert operators. A search strategy would be captured in the form of a search sequence through the present invention's search engine and then stored into a database in accordance with the illustrative embodiment of the present invention. The search engine would be outfitted with a data capture mechanism that gives each expert a way of indicating when a successful search has been completed. The search sequence is then stored into the database. The invention contemplates the possibility of more than one search sequence being stored for a given search term. The invention also contemplates the possibility of a learned search sequence being expanded and re-learned as a new search sequence.

Subsequently, call center operators would receive results from the database when submitting search terms. When the database finds a match for a given search term, it sends the corresponding search sequence(s) to the user who submitted the search term. Thus, the present invention enables search strategies to be learned and then reused. With the present invention, the search sequences themselves provide value, not merely the final destinations.

The illustrative embodiment comprises:

transmitting to a first telecommunications terminal a first document in response to a first search term;

transmitting to the first telecommunications terminal a second document in response to a user entry; and

storing in a database an indicium that the first search term is associated with the ordered sequence for presenting the first document and the second document to the first user.

Although the illustrative embodiment describes Internet or intranet searches, the system also works in an interactive voice response framework.

### BRIEF DESCRIPTION OF THE DRAWINGS

FIG. 1 depicts a schematic diagram of the salient portions of data processing system 100 according to the illustrative embodiment of the present invention.

FIG. 2 depicts a flowchart of the salient tasks of data processing system 100 according to the illustrative embodiment of the present invention.

FIG. 3 depicts a flowchart of the salient tasks associated with the performance of task 201.

FIG. 4 depicts a flowchart of the salient tasks associated with the performance of task 301.

FIG. 5 depicts a flowchart of the salient tasks associated with the performance of task 302.

FIG. 6 depicts a flowchart of the salient tasks associated with the performance of task 202.

### DETAILED DESCRIPTION

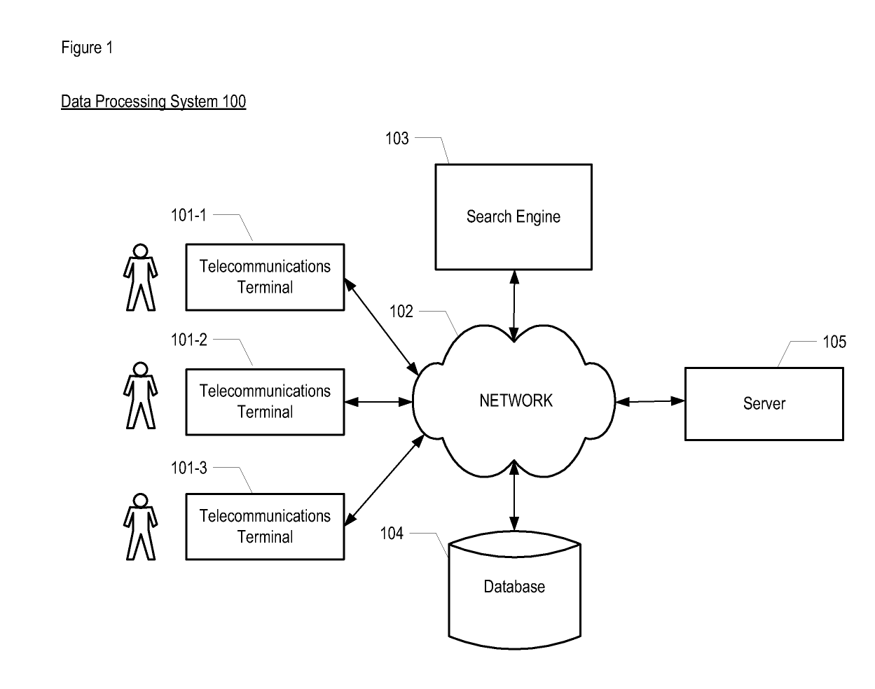

FIG. 1 depicts a schematic diagram of the salient portions of data processing system 100 according to the illustrative embodiment of the present invention. Data processing system 100 is an apparatus that comprises: telecommunications terminals 101-1, 101-2 and 101-3, network 102, search engine 103, database 104, and server 105. FIG. 1 also depicts users positioned at the telecommunications terminals.

Although the illustrative embodiment comprises three telecommunications terminals, it will be clear to those skilled in the art, after reading this disclosure, how to make and use alternative embodiments of the present invention that comprise any number of telecommunications terminals, e.g., one telecommunications terminal, two telecommunications terminals, four telecommunications terminals, etc.

Although the illustrative embodiment comprises one network 102, it will be clear to those skilled in the art, after reading this disclosure, how to make and use alternative embodiments of the present invention that comprise any number of interconnected networks, e.g., two networks, three networks, four networks, etc. Furthermore, it will be clear to those having ordinary skill in the art, after reading the present disclosure, that when an alternative embodiment of the present invention comprises more than one interconnected network, each of the other components can be connected to any one of the networks, and need not all be connected to a single network.

Although the illustrative embodiment comprises one search engine 103, it will be clear to those skilled in the art, after reading this disclosure, how to make and use alternative embodiments of the present invention that comprise any number of search engines, e.g., two search engines, three search engines, four search engines, etc.

Although the illustrative embodiment comprises one database 104, it will be clear to those skilled in the art, after reading this disclosure, how to make and use alternative embodiments of the present invention that comprise any number of databases, e.g., two databases, three databases, four databases, etc.

Although the illustrative embodiment comprises one server 105, it will be clear to those skilled in the art, after reading this disclosure, how to make and use alternative embodiments of the present invention that comprise any number of servers, e.g., two servers, three servers, four servers, etc.

Although the illustrative embodiment depicts the components of data processing system 100—telecommunications terminals 101-1, 101-2 and 101-3, search engine 103, database 104, and server 105—as being connected to each other through network 102, it will be clear to those having ordinary skill in the art, after reading the present disclosure, that one or more of these named components can be directly connected to one or more of the other components. Thus, telecommunications terminal 101-1 can be directly connected to search engine 103. Likewise, database 104 can be directly connected to search engine 103. Likewise, server 105 can be directly connected to search engine 103, etc.

Although the illustrative embodiment depicts the components of data processing system 100—telecommunications terminals 101-1, 101-2 and 101-3, network 102, search engine 103, database 104, and server 105—as being separate from one another, it will be clear to those having ordinary skill in the art, after reading the present disclosure, that a single physical device can comprise one or more of these named components. Thus, one physical device could comprise search engine 103 and database 104. Likewise a single physical device could comprise search engine 103 and server 105, etc.

Telecommunications terminals 101-1, 101-2 and 101-3 are well-known prior art hardware that is a personal computer. It will be clear to those having ordinary skill in the art, after reading the present disclosure, that in alternative embodiments of the present invention telecommunications terminals 101-1, 101-2 and 101-3 can be any personal computer platform, a computer terminal, a personal digital assistant, a Blackberry, an iPhone, a telephone, a wireless telephone, or any device capable of transmitting user input and receiving information in response. It will be clear to those having ordinary skill in the art, after reading this disclosure, that any discussion in this specification about any one of telecommunications terminal 101-1, 101-2, or 101-3 equally applies to any one of the other two telecommunications terminals.

Telecommunications terminals 101-1, 101-2 and 101-3 transmit user input through network 102 to search engine 103, to server 105, and to database 104. Telecommunications terminals 101-1, 101-2, and 101-3 additionally receive responses issued by search engine 103, server 105, and database 104, and present the received responses to the respective user of the telecommunications terminal. It will be clear to those having ordinary skill in the art, after reading this disclosure, that in some alternative embodiments of the present invention telecommunications terminals 101-1, 101-2, and 101-3 do not transmit to or receive from database 104 or server 105 or both.

Network 102 is a data network well known in the prior art. It will be clear to those having ordinary skill in the art that network 102 could be an Internet Protocol (“IP”) network, a telecommunications network, a mixed voice and data network, or any kind of network that sustains transmission of information. It will be clear to those having ordinary skill in the art that network 102 can be the public Internet or a private “intranet,” or a combination of Internet and intranet.

Search engine 103 is hardware that receives and transmits information to telecommunications terminals 101-1, 101-2, and 101-3, database 104, and server 105 and search engine 103 interprets information and composes communications that it transmits to other components of processing system 100. It will be clear to those having ordinary skill in the art, after reading the present disclosure, how search engine 103 receives, interprets, composes, and transmits information to and from the other components in data processing system 100.

Database 104 is hardware that stores information that can be retrieved. It will be clear to those having ordinary skill in the art, after reading the present disclosure, how the salient information of data processing system 100 is stored, organized, and retrieved from database 104.

Server 105 is well-known prior art hardware that hosts documents and makes them available to other devices. For the purposes of this specification, the term “document” is defined to include, but not be limited to, a Hypertext Markup Language (“HTML”) “Web” page, a Portable Document Format (“PDF”) document, a Microsoft Word document, audio, images, video, interactive web sites, etc. It will be clear to those having ordinary skill in the art that server 105 can host any number of documents. Furthermore, it will be clear to those skilled in the art that a document can comprise one or more identifying datum (e.g., a hypertext link, etc.) to one or more other documents.

In the illustrative embodiment of the present invention a document is presented to the user at telecommunications terminal 101-1 in response to user action. User action comprises entering a search term, entering a URL, selecting from one or more identifying datum, clicking on a hypertext link, activating a browser button, answering a query, etc.

In accordance with the illustrative embodiment, server 105 receives requests from search engine 103 by way of a unique identifying datum. For purposes of this specification an “identifying datum” is defined as an indicium that uniquely identifies a document within the universe in which data processing system 100 operates. A universal resource locator (“URL”) is used by those skilled in the art as the identifying datum necessary to uniquely identify a World Wide Web location or an Internet location or any location on an IP intranet. For example, “http://www.avaya.com/usa/” is a URL.

In the illustrative embodiment of the present invention a URL is used as the identifying datum of information to be presented to a user. It will be clear to those having ordinary skill in the art, after reading the present disclosure, that in alternative embodiments of the present invention the identifying datum need not be a URL, but could be any other reference information that search engine 103 is capable of presenting, e.g., legal citations, newspaper citations, phone numbers, interactive voice response digits, etc.

The details of data processing system 100 are further described below. It will be clear to those having ordinary skill in the art, after reading the present disclosure, how to make and use data processing system 100.

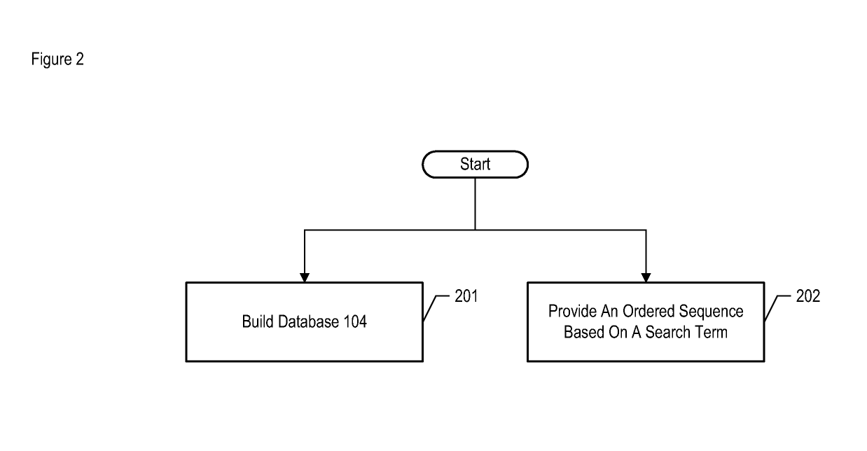

FIG. 2 depicts a flowchart of the salient tasks of data processing system 100 according to the illustrative embodiment of the present invention.

Data processing system 100 comprises task 201 and task 202. As shown in FIG. 2, these tasks operate independently.

Although the illustrative embodiment of processing system 100 comprises only two tasks, it will be clear to those having ordinary skill in the art, after reading the present disclosure, that an alternative embodiment of the present invention could have any number of tasks or sub-divisions of tasks, e.g., one task comprising task 201 and task 202, two tasks that are differently sub-divided, three tasks, four tasks, etc. Furthermore, it will be clear to those having ordinary skill in the art, after reading the present disclosure, that in alternative embodiments of the present invention tasks 201 and task 202 can operate in parallel, or alternatively, can operate interdependently and need not be independent of each other. Furthermore, it will be clear to those having ordinary skill in the art, after reading the present disclosure, that alternative embodiments of the present invention can have multiple instances of either task 201 or task 202, or both.

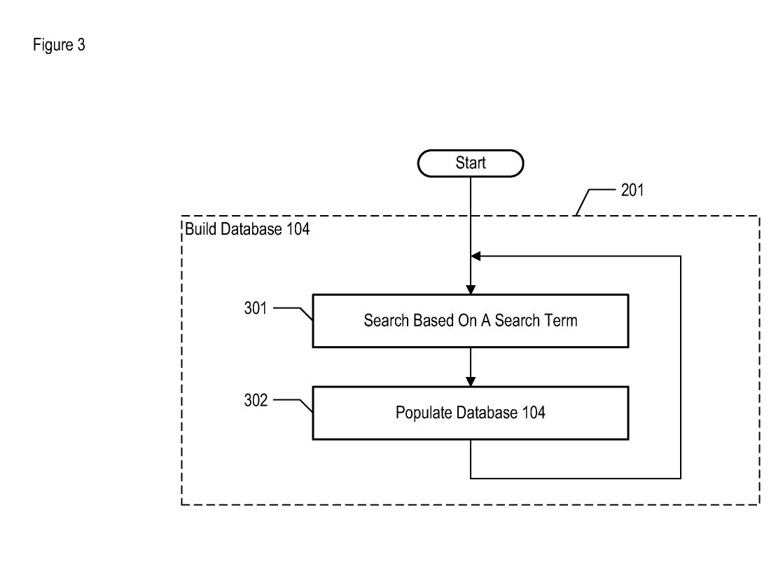

At task 201, the contents of database 104 are built. Task 201 is described in further detail in FIG. 3.

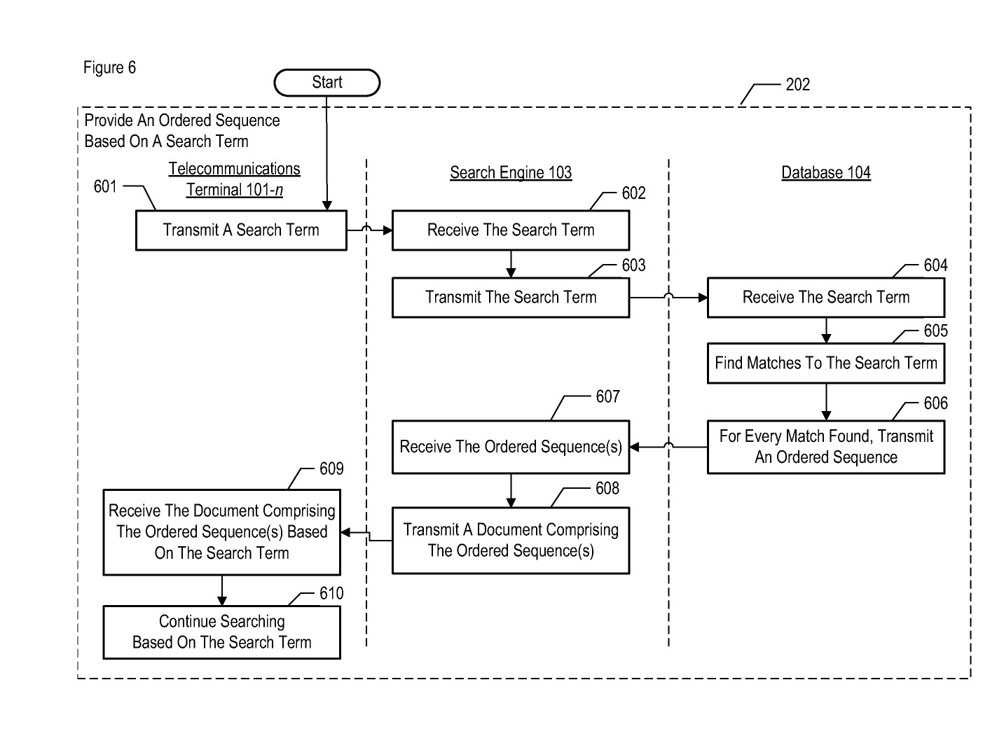

At task 202, an ordered sequence based on a search term is provided. Task 202 is described in more detail in FIG. 6. It will be clear to those skilled in the art that some executions of task 202 involve telecommunications terminal 101-1; some executions of task 202 involve telecommunications terminal 101-2; and some executions of task 202 involve telecommunications terminal 101-3.

For purposes of this specification, a “search term” is defined as an alphanumeric string transmitted from telecommunications terminal 101-1 that is used by search engine 103 to find matches throughout its universe of searchable matter. For example, “auto maintenance ford mustang 1965” is a search term transmitted from telecommunications terminal 101-1. It will be clear to those having ordinary skill in the art, after reading the present disclosure, that in alternative embodiments of the present invention the search term can comprise any number of alphanumeric characters and any number of alphanumeric strings, e.g., a one-word search term, a two-word search term, a number, two numbers, a combination of alphanumeric strings, a combination of numbers and alphanumeric strings, a telephone dialing digit, two telephone dialing digits, etc.

FIG. 3 depicts a flowchart of the salient tasks associated with the performance of task 201.

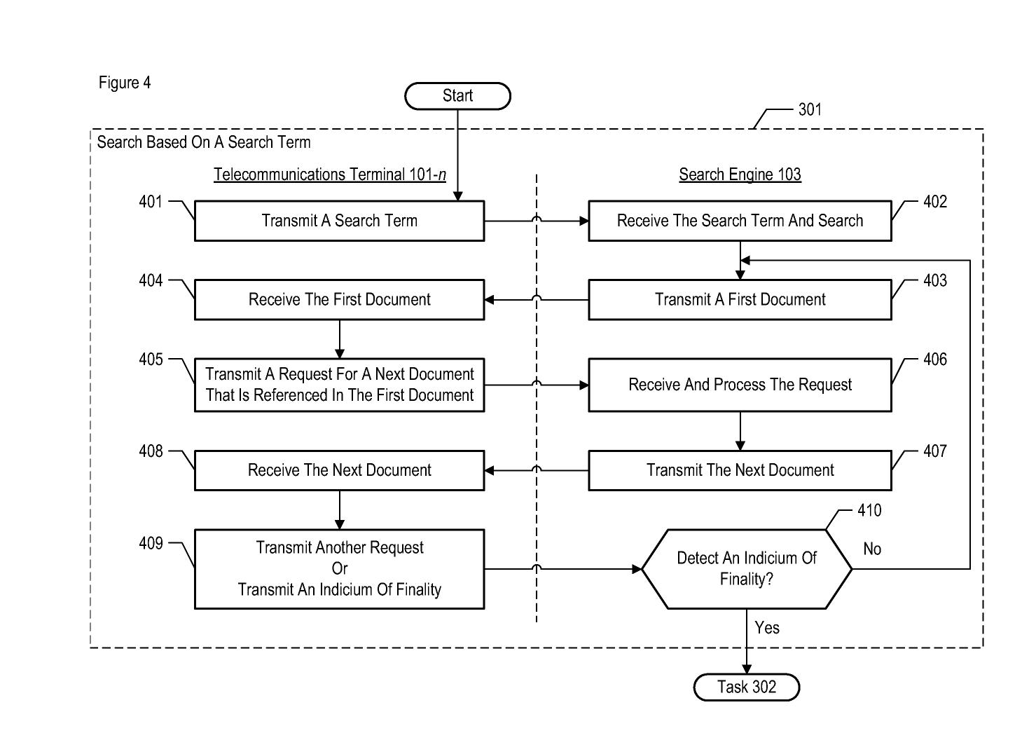

Task 301 performs a search based on a search term and is described in further detail in FIG. 4. It will be clear to those skilled in the art that some executions of task 301 involve telecommunications terminal 101-1; some executions of task 301 involve telecommunications terminal 101-2; and some executions of task 301 involve telecommunications terminal 101-3.

Task 302 populates database 104 with:
(i) the search term,
(ii) an ordered sequence for presenting a first document and a second document to a user, and
(iii) an indicium that the search term is associated with the ordered sequence for presenting the first document and the second document to the user.

FIG. 4 depicts a flowchart of the salient tasks associated with the performance of task 301. It will be clear to those skilled in the art, after reading this disclosure, that “Telecommunications Terminal 101-n” depicted in FIG. 4 means any one of the telecommunications terminals depicted in FIG. 1, i.e., telecommunications terminal 101-1, telecommunications terminal 101-2, or telecommunications terminal 101-3. For brevity in regards to FIG. 4, the description that follows refers to telecommunications terminal 101-1.

At task 401, telecommunications terminal 101-1 transmits a search term to search engine 103. For example, “auto maintenance ford mustang 1965” is a search term transmitted from telecommunications terminal 101-1. Transmitting a search term from telecommunications terminal 101-1 is well known in the art.

At task 402, search engine 103 receives the search term. Search engine 103 conducts a search based on the search term. For example, search engine 103 finds that server 105 hosts a web site that matches the search term and the web site's identifying datum is “http://www.1965mustang_maint.com.” Continuing the present example, search engine 103 finds another result at server 105, which hosts a document that matches the search term and its identifying datum is “http://www.mustangs/1965/maint_manual.pdf.”

It will be clear to those having ordinary skill in the art, after reading the present disclosure, how search engine 103 searches for, finds, and retrieves identifying data based on a search term. Although this example illustrates how search engine 103 found two results for the search term in one server, it will be clear to those having ordinary skill in the art, after reading the present disclosure, that in alternative embodiments of the present invention search engine 103 can find any number of results, e.g., no results, one, result, two results, three results, etc., in any number of servers, e.g., one server, two servers, three servers, etc. Furthermore, it will be clear to those having ordinary skill in the art, after reading the present disclosure, that in alternative embodiments of the present invention search engine 103 can find results to the search term in database 104. See FIG. 6.

At task 403, search engine 103 compiles the results of its search into a first document and transmits the document to telecommunications terminal 101-1. Continuing the previous example, the first document comprises two identifying data resulting from the search term: (1) “http://www.1965mustang_maint.com” and (2) “http://www.mustangs/1965/maint_manual.pdf.” Although this example illustrates the first document comprising only two matching results, it will be clear to those having ordinary skill in the art, after reading the present disclosure, that in alternative embodiments of the present invention search engine 103 can compile a document comprising any number of results for the search term, e.g., no results, one result, two results, three results, etc.

At task 404, telecommunications terminal 101-1 receives the first document transmitted by search engine 103. It will be clear to those having ordinary skill in the art how to receive a document at a telecommunications terminal.

At task 405, telecommunications terminal 101-1 makes a “user entry,” i.e., transmits a request to search engine 103. For purposes of this specification, a “user entry” is defined as a request at telecommunications terminal 101-1 transmitted to search engine 103. In the illustrative embodiment, the user entry is a request seeking a next document that was referenced in the first document received at task 404. It will be clear to those having ordinary skill in the art how telecommunications terminal 101-1 transmits a request to search engine 103. It will be clear to those having ordinary skill in the art, after reading the present disclosure, that in alternative embodiments of the present invention a user entry can be a document reference, a URL, a new search word, an indicium of finality (as defined below), etc. Continuing the prior example, telecommunications terminal 101-1 transmits the following request to search engine 103: “http://www.mustangs/1965/maint_manual.pdf,” which is referenced in the first document.

It will be clear to those having ordinary skill in the art, after reading the present disclosure, how to make and use alternative embodiments of the present invention in which the next requested document is not referenced in the first document, but is requested at telecommunications terminal 101-1 by the entry of a URL, or of another identifying datum, or of a second search term. This alternative embodiment is described in more detail below under the rubric of “topic of interest.”

At task 406, search engine 103 receives the request from telecommunications terminal 101-1 and processes the request by finding the document identified by the identifying datum.

At task 407, search engine 103 transmits to telecommunications terminal 101-1 the next-requested document. In the continuing example, search engine 103 transmits the document located at http://www.mustangs/1965/maint_manual.pdf. It will be clear to those having ordinary skill in the art, how to transmit a document from a search engine to a telecommunications terminal.

At task 408, telecommunications terminal 101-1 receives the document transmitted by search engine 103.

At task 409, telecommunications terminal 101-1 transmits either:
(i) another request for a new document, or
(ii) an indicium of finality.

In the present continuing example, when telecommunications terminal 101-1 transmits a request for a new document at task 409, it requests “http://www.mustangs/1965/maint_manual_previous_version.pdf,” which is an identifying datum referenced in the current document that it received at task 408, i.e., document “http://www.mustangs/1965/maint_manual.pdf.”

In the illustrative embodiment, the request for a new document is an identifying datum referenced in the previous document (i.e., the next-referenced document received at task 408), but it will be clear to those having ordinary skill in the art, after reading the present disclosure, how to make and use alternative embodiments of the present invention in which the document requested at task 409 is not referenced in the document received at task 408, but is requested at telecommunications terminal 101-1 by the entry of a URL, or of another identifying datum, or of a second search term. This alternative embodiment is described in more detail below under the rubric of “topic of interest.”

At task 410, search engine 103 decides whether it detects an indicium of finality. When search engine 103 does not detect an indicium of finality in the transmission received from telecommunications terminal 101-1, it loops back to task 403 to process and transmit the appropriate responsive document to telecommunications terminal 101-1. Thus, continuing the present example, having received a request for “http://www.mustangs/1965/maint_manual_previous_version.pdf” at task 410, having decided that it is not an indicium of finality, and having looped back to task 403, search engine 103 transmits to telecommunications terminal 101-1 the document identified as “http://www.mustangs/1965/maint_manual_previous_version.pdf.”

This process continues indefinitely as described above until telecommunications terminal 101-1 transmits an indicium of finality at task 409.

For purposes of this specification, an “indicium of finality” is defined as an indication or marker that communicates an end to the present search based on the search term. The indicium of finality arises from action at telecommunications terminal 101-1 which in turn triggers an interpretive task in search engine 103 at task 410.

The action at telecommunications terminal 101-1 that transmits an indicium of finality can be either express or implied. An express action is when telecommunications terminal 101-1 activates a special-purpose button on a web browser that is designated to transmit the indicium of finality of the present search, i.e., the button signals that the search has ended. In the illustrative embodiment of the present invention, the special-purpose button is a browser push-button. It will be clear to those having ordinary skill in the art, after reading the present disclosure, that in other embodiments of the present invention the special-purpose button can be a check mark, a radio button, or any number of indicators in a web browser, or a sequence of digits in an interactive voice response system, or a voice command in an interactive voice response system, or any like user interface.

Another express action to activate the indicium of finality is when telecommunications terminal 101-1 transmits an affirmative answer to a query that indicates an end to the present search based on the search term. In one illustrative embodiment of the present invention, search engine 103 presents telecommunications terminal 101-1 with an “end-of-search” query with every responsive document it transmits to telecommunications terminal 101-1. When telecommunications terminal 101-1 affirmatively answers the end-of-search query, it transmits an express indicium of finality to search engine 103. It will be clear to those having ordinary skill in the art, after reading the present disclosure, that in other embodiments of the present invention that the end-of-search query can be a specially-formulated search term. It will be clear to those having ordinary skill in the art, after reading the present disclosure, how to make and use an express indicium of finality, including how to make and use a special-purpose button and how to make and use an end-of-search query.

An implied indicium of finality is when action taken at telecommunications terminal 101-1 is interpreted by search engine 103 at task 410 as representing an end to the search based on the search term. In one illustrative embodiment of the present invention telecommunications terminal 101-1 transmits a new search term to search engine 103.

In an alternative embodiment of the present invention the implied indicium of finality is a payment transaction at telecommunications terminal 101-1, meaning that a successful search has resulted in a purchase. In an alternative embodiment of the present invention the implied indicium of finality is when the URL transitions from a non-secure transmission method to a secure transmission method, such as would be associated with a payment transaction. For example, when a first document's URL begins with “http://” it is understood by those skilled in the art to signify a non-secure transmission method and to be the indentifying datum of a non-secure web site, but when a second document's URL begins with “https://” it is understood by those skilled in the art to signify a secure transmission method and to be the identifying datum of a secure web site. Thus, in an ordered sequence, after navigating a non-secure web site with an “http://” URL, reaching a secure web site with an “https://” URL, can be an indicium of finality. It will be clear to those having ordinary skill in the art, after reading the present disclosure, that in alternative embodiments of the present invention the identifying datum of a secure web site can take a different form than an “https://” URL.

In an alternative embodiment of the present invention the implied indicium of finality is an entry of a URL at telecommunications terminal 101-1 that is a departure from continuing the search via the references available in the current document received from search engine 103. In an alternative embodiment of the present invention the implied indicium of finality is receiving a user survey at telecommunications terminal 101-1, i.e., search engine 103 relies on the underlying application accessed by the user having detected an event precipitating a survey, thus signaling to search engine 103 the end of the search based on the search term.

In an alternative embodiment of the present invention a new search term is not an indicium of finality so long as the new search term and the preceding search term both are in the same “topic of interest.” For purposes of this specification, a topic of interest is defined as a category comprising a plurality of terms that pertain to similar subject matter, wherein the categorization is at the discretion of those who implement search engine 103. When a new search term falls within the same topic of interest as the preceding search term, search engine 103 continues to accumulate and append to the ordered sequence that will ultimately be stored in database 104 as pertaining to the original search term. Thus, like search terms or like subjects can be grouped into topics of interest that might yield fruitful search results to future users. It will be clear to those having ordinary skill in the art, after reading the present disclosure, that in alternative embodiments of the present invention, a URL entered by a user is not an indicium of finality so long as it is in the same topic of interest as the search term that preceded it.

It will be clear to those having ordinary skill in the art, after reading the present disclosure, how to make and use search engine 103 to comprise modes of operation with one or more topics of interest. For example, in one embodiment of the present invention, when the first search term is “cat” and the second search term is “kitten” and search engine 103 has a topic of interest that comprises both of these terms, search engine 103 will interpret search term “kitten” as a continuation of the search based on the search term “cat” and will not interpret “kitten” as an indicium of finality. In a contrasting example, when the first search term is “cat” and the second search term is “cab,” and “cab” is not in the same topic of interest as “cat,” search engine 103 will interpret “cab” as an indicium of finality.

It will be clear to those having ordinary skill in the art, after reading the present disclosure, that in alternative embodiments of the present invention telecommunications terminal 101-1 can transmit the indicium of finality through a plurality of actions and that search engine 103 can detect an indicium of finality from a combination of actions. It will be clear to those having ordinary skill in the art, after reading the present disclosure, that in alternative embodiments of the present invention telecommunications terminal 101-1 can transmit a variety of indicia of finality and that search engine 103 can detect any one of the indicia of finality at task 410.

When search engine 103 detects an indicium of finality at task 410, task 301 ends and proceeds to task 302.

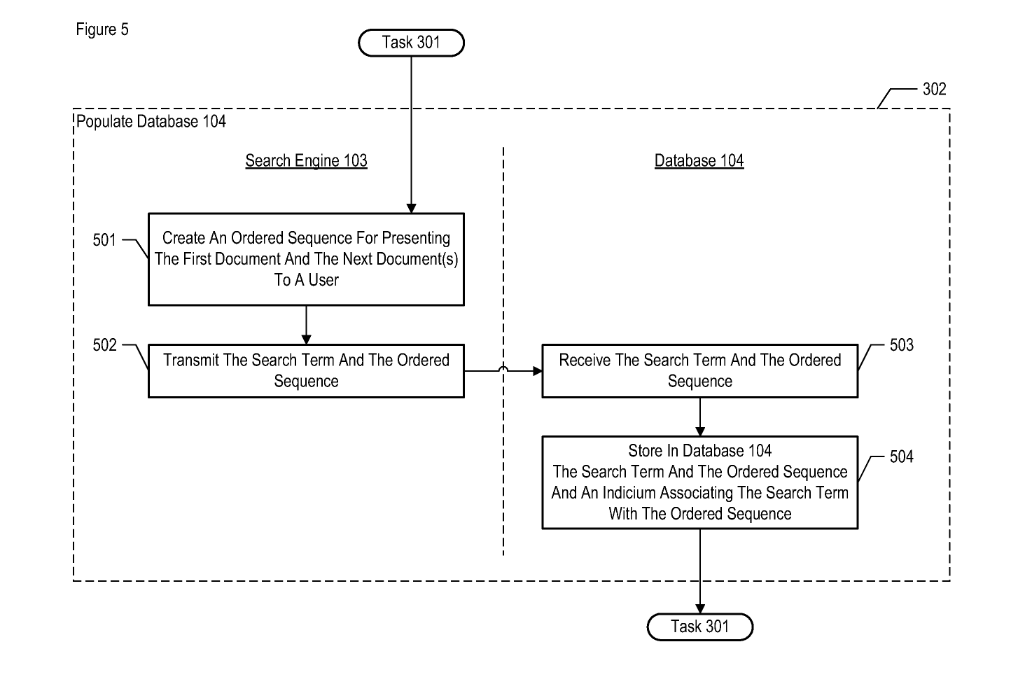

FIG. 5 depicts a flowchart of the salient tasks associated with the performance of task 302. It will be clear to those having ordinary skill in the art, after reading the present disclosure, how to make and use task 302.

At task 501, search engine 103 creates an ordered sequence for reading the first document and the next document(s) that pertain to the search term, ordering the sequence in the temporal order in which the documents were transmitted to telecommunications terminal 101-1. In the continuing examples presented above, the ordered sequence at task 501 is shown in Table 1 below:

| Document in the | |
|---|---|
| Ordered Sequence | Identifying Datum |
| First Document | http://www.1965mustang_maint.com and |
| | http://www.mustangs/1965/maint_manual.pdf |
| Second Document | http://www.mustangs/1965/maint_manual.pdf |
| Third Document (end of | http://www.mustangs/1965/maint_manual_previous_version.pdf |
| ordered sequence) | |

All three documents in Table 1 pertain to the search term illustrated in this example, namely “auto maintenance ford mustang 1965.” Each successive document in Table 1 was referenced in the previous document. Thus, the second document was referenced in the first document, and the third document was referenced in the second document.

For every additional iteration of task 403, a new document is added to the ordered sequence of task 501 so that the ordered sequence comprises, in temporal order, all the documents presented to telecommunications terminal 101-1 for the current search term. In the example of Table 1, a total of three documents were transmitted by search engine 103 to telecommunications terminal 101-1 within the present search based on the search term and therefore the ordered sequence at task 501 comprises these three documents.

Although the identifying datum in the illustrative embodiment shown in Table 1 is represented by URL(s), it will be clear to those having ordinary skill in the art, after reading the present disclosure that in alternative embodiments of the present invention the identifying datum can be a phone number, an interactive voice response digit, a voice command, etc. Furthermore, although the illustrative embodiment shown in Table 1 has an ordered sequence of three documents, it will be clear to those having ordinary skill in the art, after reading the present disclosure, that in alternative embodiments of the present invention the ordered sequence can comprise any number of documents each of which can comprise any number of identifying data, e.g., the ordered sequence can comprise two documents, or four documents, or five documents, etc., and each document can comprise three identifying data, or four identifying data, or five identifying data, etc. It will be clear to those having ordinary skill in the art, after reading the present disclosure, how to make and use the ordered sequence at task 501.

Creating the ordered sequence at task 501 in response to detecting the indicium of finality at task 410 also means that additional documents transmitted by telecommunications terminal 101-1 after the indicium of finality is detected at task 410 will not be appended to the ordered sequence. In other words, the indicium of finality marks the end of the present ordered sequence.

At task 502, search engine 103 transmits to database 104 the ordered sequence created at task 501 and the search term that gave rise to the ordered sequence. It will be clear to those having ordinary skill in the art, after reading the present disclosure, how to transmit the information at task 502.

At task 503, database 104 receives the information transmitted at task 502 by search engine 103, i.e., receives the ordered sequence created at task 501 and the search term that gave rise to the ordered sequence.

At task 504, database 104 stores the following:
(i) the search term,
(ii) the ordered sequence, and
(iii) an indicium that the search term is associated with the ordered sequence.

Thus, database 104 forms an association between a search term and an ordered sequence of documents that have collectively led to an indicium of finality for that search term. The indicium of association can be express or implied, depending upon the data structures used for database 104. It will be clear to those having ordinary skill in the art, after reading the present disclosure, how to associate a search term with an ordered sequence for the search term. In the illustrative embodiment of the present invention, in the continuing example presented above, database 104 stores an entry as shown in Table 2 below:

| Search Term: | auto maintenance ford mustang 1965 |
|---|---|
| Ordered Sequence | http://www.1965mustang_maint.com and |
| Associated with the | http://www.mustangs/1965/maint_manual.pdf |
| Search Term: | http://www.mustangs/1965/maint_manual.pdf |
| | http://www.mustangs/1965/maint_manual_previous_version.pdf |

The end of task 504 ends one iteration of task 302. When task 302 ends, it loops back to task 301, as shown in FIG. 3.

Subsequent iterations of task 301 can yield new and different results for the same search term when the user employs a different search strategy. In a subsequent iteration of task 301, when using the same search term as before and choosing differently from among the documents transmitted by search engine 103, an ordered sequence results that differs from the ordered sequence previously stored for the search term. Thus, at task 504, database 104 populates a distinct entry for the search term by adding a new and different ordered sequence. In accordance with the illustrative embodiment of the present invention, database 104 is shown in Table 3 below, illustrating three iterations of task 302 based on the same search term “X”:

| | X | X | X |
|---|---|---|---|
| | (after the first | (after the second | (after the third |
| | iteration of | iteration of | iteration of task |
| Search Term: | task 302) | task 302) | 302) |
| Ordered Sequence | DOC1 | DOC1 | DOC1 |
| Associated with | DOC2 | DOC2 | DOC11 |
| the Search | DOC3 | DOC3 | |
| Term: | | DOC4 | |

Table 3 illustrates one embodiment of the present invention, but it will be clear to those having ordinary skill in the art, after reading the present disclosure, that an entry in database 104 can be structured in other ways that comprise the search term, the ordered sequence, and the association between them. For example, another way of structuring database 104 is shown in Table 4 below:

| List of | List of Sequences | |
|---|---|---|
| Search Terms | | Associated with |
| X | Ordered Sequence | Search Term |
| Y | DOC1, DOC2, DOC3 | X |
| Z | DOC1, DOC2, DOC3, DOC4 | X |
| | DOC1, DOC11 | X |
| | DOC5, DOC6, DOC7 | Y |
| | DOC4, DOC8, DOC9, DOC10 | Z |
| | DOC4, DOC8, DOC11, DOC12 | Z |

Although Table 3 and Table 4 show no more than three ordered sequences associated with a given search term, it will be clear to those having ordinary skill in the art, after reading the present disclosure, that in alternative embodiments of the present invention database 104 can store any number of ordered sequences in association with a given search term, e.g., four ordered sequences, five ordered sequences, etc.

FIG. 6 depicts a flowchart of the salient tasks associated with the performance of task 202. It will be clear to those having ordinary skill in the art, after reading the present disclosure, how to make and use task 202. It will be clear to those skilled in the art, after reading this disclosure, that “Telecommunications Terminal 101-n” depicted in FIG. 6 means any one of the telecommunications terminals depicted in FIG. 1, i.e., telecommunications terminal 101-1, telecommunications terminal 101-2, or telecommunications terminal 101-3. For brevity in regards to FIG. 6, the description that follows refers to telecommunications terminal 101-1.

At task 601, telecommunications terminal 101-1 transmits a search term to search engine 103. It will be clear to those having ordinary skill in the art how to transmit a search term.

At task 602 search engine 103 receives the search term transmitted by telecommunications terminal 101-1 in a manner well known in the art.

At task 603, search engine 103 transmits the search term to database 104. It will be clear to those having ordinary skill in the art, after reading the present disclosure, how to transmit data and information from search engine 103 to database 104.

At task 604, database 104 receives the search term. It will be clear to those having ordinary skill in the art, after reading the present disclosure, how to receive data from search engine 103 to database 104.

At task 605, database 104 searches for a match to the search term it received from search engine 103. In the illustrative embodiment of the present invention, database 104 is populated as shown in Table 4 above. Thus, for search term “X” database 104 finds three matches.

At task 606, for each match found to the search term, database 104 transmits an associated ordered sequence to search engine 103. In the illustrative embodiment in accordance with Table 4, database 104 finds three matches for search term “X” and transmits the following three ordered sequences associated with “X”: (i) “DOC1, DOC2, DOC3,” (ii) “DOC1, DOC2, DOC3, DOC4,” and (iii) “DOC1, DOC11.” Although the illustrative embodiment of the present invention has three matches found for a search term, it will be clear to those having ordinary skill in the art, after reading the present disclosure, that in alternative embodiments of the present invention database 104 can find any number of matches, i.e., no matches, one match, two matches, etc., and can transmit any corresponding number of ordered sequences associated with a given search term, e.g., no ordered sequence, one ordered sequence, two ordered sequences, etc.

At task 607, search engine 103 receives the ordered sequences associated with search term “X” transmitted by database 104, i.e., (i) “DOC1, DOC2, DOC3,” (ii) “DOC1, DOC2, DOC3, DOC4,” and (iii) “DOC1, DOC11.”

At task 608, search engine 103 transmits to telecommunications terminal 101-1 a document that comprises the ordered sequences received from database 104. Thus, in response to search term “X” search engine 103 transmits a document that comprises three ordered sequences: (i) “DOC1, DOC2, DOC3,” (ii) “DOC1, DOC2, DOC3, DOC4,” and (iii) “DOC1, DOC11.”

Although this illustrative example has a document that comprises three ordered sequences corresponding to the search term, it will be clear to those having ordinary skill in the art, after reading the present disclosure, that in alternative embodiments of the present invention the document transmitted by search engine 103 at task 608 may comprise additional information, may transmit the ordered sequences in different formats than illustrated here, may combine other search results with database 104 results, may present the ordered sequences in a different order than (i), (ii), and (iii) as illustrated here, may transmit results one at a time, etc.

In an alternative embodiment of the present invention, search engine 103 monitors the user's search and assists the user's navigation through a toolbar that indicates the preferred next step in the ordered sequence that the user is presently navigating. It will be clear to those having ordinary skill in the art, after reading the present disclosure, that in alternative embodiments of the present invention, search engine 103 highlights or otherwise points to the preferred next step in the ordered sequence that the user is presently navigating. Thus, the user is presented with many navigational options and search engine 103 assists in regards to at least one ordered sequence that matches the search term.

At task 609, telecommunications terminal 101-1 receives the document comprising the ordered sequence(s) transmitted by search engine 103.

At task 610, telecommunications terminal 101-1 continues the search based on the search term, using the results it received from search engine 103. In the illustrative embodiment of the present invention, in the continuing example presented above, telecommunications terminal 101-1 selects the first ordered sequence transmitted by search engine 103, i.e., “DOC1, DOC2, DOC3.” Telecommunications terminal 101-1 then navigates to the document with identifying datum “DOC1.” Telecommunications terminal 101-1 then navigates to the document with identifying datum “DOC2” and then to the document with identifying datum “DOC3,” successfully reaching the same endpoint as the user who initially created this ordered sequence.

Although in the illustrative embodiment of the present invention telecommunications terminal 101-1 navigates the ordered sequence in the same order as presented by the sequence, it will be clear to those having ordinary skill in the art, after reading the present disclosure, that in alternative embodiments of the present invention telecommunications terminal 101-1 can navigate an ordered sequence transmitted by search engine 103 in any order. It will be clear to those having ordinary skill in the art, after reading the present disclosure, how to make and use task 610 such that the ordered sequence is available to telecommunications terminal 101-1 to navigate in any order. It will be clear to those having ordinary skill in the art, after reading the present disclosure, how to make and use task 610.

When task 610 ends, this ends task 202. As noted earlier, it will be clear to those having ordinary skill in the art, after reading the present disclosure, that in alternative embodiments of the present invention tasks 201 and 202 can operate interdependently, so that ordered sequences that are populated into database 104 at task 201 are transmitted to a telecommunications terminal in response to a search at task 202. This means that data processing system 100 is capable of both learning ordered sequences and retrieving those sequences when tasks 201 and 202 are interdependent.

Furthermore, it will be clear to those having ordinary skill in the art, after reading the present disclosure, that in alternative embodiments of the present invention task 402 comprises searching both database 104 and prior art servers like server 105. Likewise, it will be clear to those having ordinary skill in the art, after reading the present disclosure, that in alternative embodiments of the present invention task 608 comprises results from both prior art servers like server 105 and from database 104.

It is understood that this disclosure teaches just some examples of how the tasks of processing system 100 are ordered and organized and that many different variations can be devised by those skilled in the art after reading this disclosure. It is further understood that the scope of the present invention is to be determined by the following claims.

1. A method comprising:
transmitting to a first telecommunications terminal a first document in response to a first search term;
transmitting to the first telecommunications terminal a second document in response to a user entry; and
storing in a database an indicium that the first search term is associated with an ordered sequence for presenting the first document and the second document to a first user.

2. The method of claim 1 wherein the user entry is an identifying datum that is referenced in the first document.

3. The method of claim 1 wherein the user entry is a second search term, and wherein a topic of interest comprises the first search term and the user entry.

4. The method of claim 1 wherein the user entry is a uniform resource locator, and wherein a topic of interest comprises the first search term and the user entry.

5. The method of claim 1 further comprising:
in response to the first search term from a second telecommunications terminal, transmitting to the second telecommunications terminal the ordered sequence for presenting the first document and the second document to a second user.

6. The method of claim 1 further comprising:
in response to detecting an indicium of finality with respect to the second document, preventing an identifying datum of a third document from being appended to the ordered sequence for presenting the first document and the second document to a second user.

7. A method comprising:
transmitting to a first telecommunications terminal a first ordered sequence for presenting a first document and a second document to a first user in response to a first search term;
transmitting to the first telecommunications terminal a third document in response to a user entry; and
storing in a database an indicium that the first search term is associated with a second ordered sequence for presenting the first document, the second document, and the third document to a second user.

8. The method of claim 7 wherein the user entry is an identifying datum that is referenced in at least one of the first document and the second document.

9. The method of claim 7 further comprising:
in response to the first search term from a second telecommunications terminal, transmitting to the second telecommunications terminal the ordered sequence for presenting the first document, the second document, and the third document to a third user.

10. A method comprising:
transmitting to a first telecommunications terminal a first document in response to a search term;
transmitting to the first telecommunications terminal a second document in response to a first user entry;
storing in a database a first indicium that the search term is associated with a first ordered sequence for presenting the first document and the second document to a first user;
transmitting to a second telecommunications terminal a third document in response to the search term;
transmitting to the second telecommunications terminal a fourth document in response to a second user entry; and
storing in the database a second indicium that the search term is associated with a second ordered sequence for presenting the third document and the fourth document to a second user;
wherein at least one of:
(i) the first document is different than the third document, and
(ii) the second document is different than the fourth document is true.

11. The method of claim 10 wherein the first user entry is an identifying datum that is referenced in the first document.

12. The method of claim 10 wherein the second user entry is an identifying datum that is referenced in the third document.

13. The method of claim 10 further comprising:
in response to receiving the search term, transmitting to a third telecommunications terminal:
(i) the first ordered sequence for presenting the first document and the second document to a third user, and
(ii) the second ordered sequence for presenting the third document and the fourth document to the third user.

14. A method comprising:
receiving an indicium of finality with respect to a document transmitted to a telecommunications terminal; and
in response to receiving the indicium of finality, storing in a database an ordered sequence for presenting a plurality of documents to a user in which an identifying datum of the document is the last identifying datum in the ordered sequence for presenting a plurality of documents to a user.

15. The method of claim 14 wherein the indicium of finality is a button in a web browser.

16. The method of claim 14 wherein the indicium of finality is a response to a query presented by the document.

17. The method of claim 14 wherein the indicium of finality comprises the entry of a payment.

18. The method of claim 14 wherein the indicium of finality comprises an identifying datum of a secure website.

19. The method of claim 14 wherein the indicium of finality comprises the entry of a uniform resource locator.

20. The method of claim 14 wherein the indicium of finality is a user survey transmitted to the first telecommunications terminal.

21. The method of claim 14 further comprising:
in response to receiving the indicium of finality, storing in the database an indicium that the first search term is associated with the ordered sequence for presenting a plurality of documents to the user.

22. The method of claim 21 wherein the indicium of finality comprises the entry of a second search term.

23. The method of claim 21 wherein the indicium of finality is a button in a web browser.

24. The method of claim 21 wherein the indicium of finality is a response to a query presented by the document.

25. The method of claim 21 wherein the indicium of finality comprises an identifying datum of a secure website.

26. A method comprising:
receiving a search term; and
in response to the search term, transmitting an ordered sequence for presenting a first document and a second document to a user.

27. The method of claim 26 wherein a database comprises:
(i) the search term,
(ii) the ordered sequence for presenting the first document and the second document to the user, and
(iii) an indicium that the search term is associated with the ordered sequence for presenting the first document and the second document to the user.
